(19) United States
(12) Patent Application Publication
(10) Pub. No.: US 2005/0082378 A1
(43) Pub. Date: Apr. 21, 2005

(54) Adjustable electric thermostat actuator

(76) Inventors: Eric Beishline, Marlborough, MA (US); Thomas P. Schregardus, Somerville, MA (US); Mark Oakes, Duxbury, MA (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/924,273

(22) Filed: Aug. 23, 2004

Related U.S. Application Data
(60) Provisional application No. 60/497,176, filed on Aug. 22, 2003.

(51) Int. Cl. G05D 15/00; G05B 13/00

(52) U.S. Cl. 236/74 R

(57) ABSTRACT

An thermostat actuator is provided for controlling a flow rate of coolant through a cooling system. The actuator includes a motor and a drive train including an anti-back-drive mechanism. The actuator further includes an integral position feedback system that for indicating a position of an element of the actuator to ensure that the actuator has moved to a commanded position. The actuator is configured to be readily adaptable to different position feedback systems providing varying degrees of position feedback resolution.

### CROSS-REFERENCE TO RELATED APPLICATIONS

This application claims the benefit of U.S. provisional patent application Ser. No. 60/497,176, filed Aug. 22, 2003, the entire disclosure of which is incorporated by reference.

### FIELD

The present disclosure relates generally to actuators, and, more particularly to adjustable electric thermostat actuators for use in fluid coolant systems.

### BACKGROUND

Generally, internal combustion engines rely on a fluid coolant system to prevent overheating. These coolant systems rely on a thermostat to regulate the engine temperature by opening and closing an orifice, e.g. through operation of a conventional wax motor, to regulate fluid flow through the overall thermal management system. In today's vehicles, the ability to improve the thermal management system can improve engine durability, overall performance and fuel economy.

Accordingly, it is desirable to efficiently control fluid flow in such fluid coolant systems.

### BRIEF DESCRIPTION OF THE DRAWINGS

Features and advantages of the claimed subject matter will be apparent from the following detailed description of exemplary embodiments thereof, which description should be considered in conjunction with the accompanying drawings, in which:

FIG. 1 is a block diagram of an exemplary adjustable electric thermostat actuator consistent with the present disclosure.

FIG. 1A illustrates an embodiment of a three-wire, contact switch position feedback system suitable for use with an actuator consistent with the present disclosure;

FIG. 2 illustrates an embodiment of a two-wire, resistor ladder type position feedback system suitable for use with an actuator consistent with the present disclosure;

FIG. 3A illustrates an embodiment of a three-wire resistor ladder feedback system that may be suitable for use with an actuator consistent with the present disclosure;

FIG. 3B depicts a voltage-position plot produced by the feedback system illustrated in FIG.3A;

FIG. 4 is a voltage-position plot for a position feedback system utilizing a potentiometer;

FIG. 5 is an embodiment of another two-switch position feedback system that may suitably be used with an actuator according to the present disclosure;

FIG. 6A depicts a pulse type position feedback system that may suitably be used with an actuator according to the present disclosure;

FIG. 6B is a voltage-position plot for the position feedback system of FIG. 6A;

FIG. 7 is a perspective view of an embodiment of an actuator consistent with the present disclosure;

FIG. 8 shows the actuator of FIG. 7 with a cover portion removed;

FIG. 9 is a top view of an embodiment of an actuator consistent with the present disclosure;

FIG. 10 is a side view of the actuator illustrated in FIG. 9; and

FIG. 11 is an end view of the actuator illustrated in FIG. 9.

### DETAILED DESCRIPTION

In general, an actuator is provided having an integral position feedback system. The actuator may be readily adaptable to providing different levels of feedback resolution in response to different system requirements. In one embodiment, the actuator may be configured as an adjustable electric thermostat actuator in a coolant system. According to such an embodiment, the adjustable electric thermostat actuator may not only provide a fully opened and a fully closed position of a movable element, such as a valve, but may also provide finer resolution and control of coolant fluid flow between the fully open and the fully closed levels. Consistent with one aspect of the present disclosure, an adjustable electric thermostat actuator may be configured with a non-back-drivable gear train. The non-back-drivable gear train may allow the actuator to maintain a desired position of a moveable element against pressure and/or fluid movement in the coolant system. Additionally, an integral position feedback of the actuator may be provided having any of various design configurations. Accordingly, the adjustable electric thermostat actuator may provide anti-back-drive to ensure an element driven by the actuator may achieve and retain a commanded position, may be of small package size to meet industry packaging requirements, and may be a low cost design, especially when compared to other motor technologies such as brushless/stepper motor technology.

In an embodiment consistent with the present disclosure, a thermostat, e.g., for a vehicle cooling system, may be configured in such a way that the operating conditions of the thermostat may rely on two primary movers: 1) a conventional wax motor that may fully open/fully close an orifice and 2) an auxiliary actuator that may move a control element to regulate fluid flow through the system at a much finer resolution. In one such embodiment consistent with the present disclosure, the wax motor may move a plunger to fully open/fully close the orifice. The actuator may be adapted to move the plunger from a fully opened condition to at least partially close the orifice, thereby controlling fluid flow through the orifice to a greater degree than capable with the traditional wax motor alone. According to another embodiment, the actuator may act on a separate control element that is not operated by the wax motor. The separate control element may be adapted to influence the flow of fluid in at least a portion of the cooling system, for example, when the wax motor is in a fully opened condition.

According to one aspect of the present disclosure, the actuator may be configured with an integral position feedback system. Accordingly, a coolant system may be provided including an auxiliary actuator and a control system that may not just simply command the actuator to move from point A to point B, in which points A and B, or the distance from point A to point B, may be defined in terms rotary position or displacement. Rather, the actuator may provide feedback to an engine control module, or other control module, regarding the position and/or movement of the actuator. It is thus possible to ensure or indicate that the actuator has completed the commanded movement. Accordingly, the feedback system may be adapted to provide an output indicative of a position or movement of a component of the actuator, e.g., an actuator motor, an element of an actuator gear train, an actuator output shaft or plunger, etc.

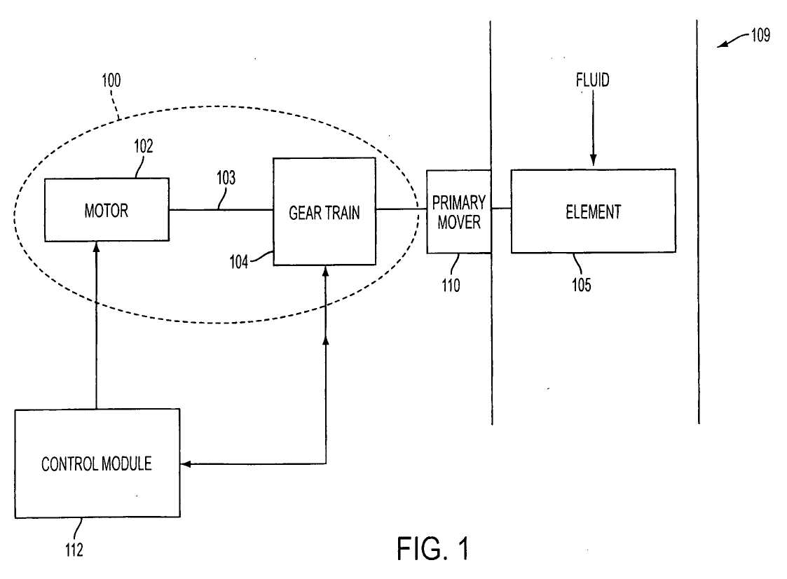

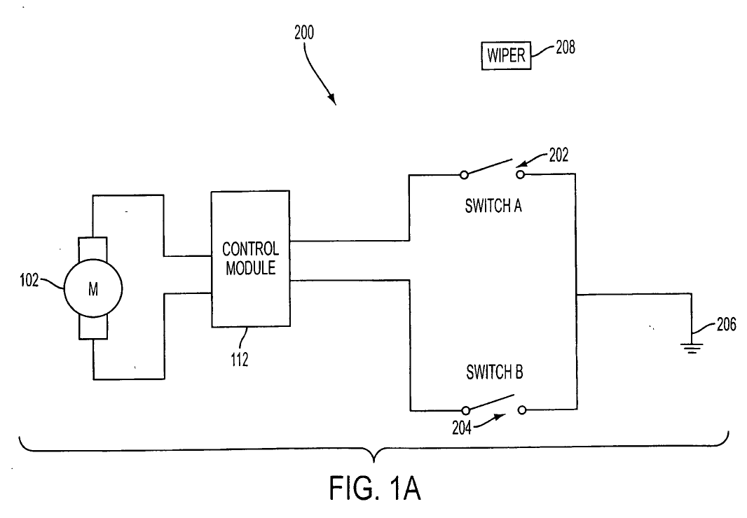

Turning to FIG. 1, a broad system level block diagram of an exemplary adjustable electric thermostat actuator 100 consistent with the disclosure is illustrated. The actuator 100 may include a motor 102 having an output shaft 103 to drive a gear train 104. The gear train 104 may drive an element 105, e.g., a valve, between at least a first position and at least a second position to control the flow of fluid in a fluid control cooling system 109. According to one embodiment, the first position may be a fully open position of the element 105, and the second position may be a fully closed position of the element 105. According to a related embodiment, the first position may be a fully open position and at least a second position may be a partially open position.

According to one embodiment, the cooling system 109 may include a heat exchanger, for example a radiator. When coolant is allowed-to flow through the heat exchanger the temperature of the coolant may be reduced, as in a typical vehicle cooling system. In other cooling systems, flow of coolant through the heat exchanger may serve to increase the temperature of the coolant. The flow of coolant through the heat exchanger may be controlled by opening and closing the control element 105. Accordingly, the temperature of the coolant may be regulated by controlling the flow of the coolant through the heat exchanger.

As mentioned previously, the thermostat actuator 100 may be used in conjunction with a primary thermostat mover 110. The primary thermostat mover 110 may move the control element 105 between a fully opened and a fully closed position. In the fully closed position fluid flow may be blocked through at least a portion of the cooling system 109. When the primary thermostat mover 110 is in a fully opened condition fluid flow may be permitted through the cooling system 109. According to one embodiment, the primary thermostat mover 110 may utilize a conventional motor, e.g. a wax motor, to open/close a valve or the control element 105. The primary thermostat mover 110 may also be capable of moving the control element 105 to a fully opened position at a predetermined opening temperature, and may move the control element 105 to a fully closed position when the temperature of the coolant is below the predetermined opening temperature.

In one embodiment, the actuator 100 may operate in conjunction with the primary thermostat mover 110 to provide more control of the fluid flowing through the cooling system 109. For example, rather than the fully opened or fully closed position provided by the primary thermostat mover 110, the actuator 100 may operate to provide partially opened condition to control the flow of coolant through at least a portion of the cooling system 109.

Consistent with the present disclosure, when the primary thermostat mover 110 is in a fully opened position the thermostat actuator 100 may act on the control element 105 to move the control element 105 to an at least partially closed condition to thereby at least partially restrict the flow of coolant through the cooling system. According to one embodiment when the control element 105 is in an open condition, the actuator 100 may drive a plunger, or other output, that may act against the control element 105 to at least partially close the orifice.

The actuator 100 may be energized in response to a measured temperature of the coolant, e.g., by a thermo-sensor coupled to the coolant system 109, or by a component whose temperature or performance is effected by the temperature of the coolant. In such an embodiment, the actuator 100 may be operated to provide higher resolution flow control through at least a portion of the coolant system 109, for example to provide higher resolution flow control of coolant through the heat exchanger, to thereby provide more accurate and/or consistent coolant temperature control.

An element of the actuator 100 or the control element 105 may include a feedback arrangement to indicate the position of the control element 105 or an element the actuator 100, which may correspond to a position of the control element 105 or to a flow condition through the coolant system 109. According to one aspect, the feedback system may indicate that the actuator has indeed moved to the desired or commanded position. As shown in FIG. 1, for example, a position feedback output may be provided to a control module 112 to indicate the position of the element 105, or to indicate that the actuator 100 has indeed moved the element 105 to the desired position. The control module 112 may also, in some embodiments, provide a control signal to the actuator motor 102 to drive the actuator 100 to a desired position in response to, or based on, the position feedback output to the control module 112.

In various embodiments consistent with the invention, the actuator 100 may include a motor 102 coupled to a gear train 104. Consistent with the present disclosure, the motor 102 may be either directly or indirectly coupled to the gear train 104. According to some configurations, the gear train 164 may include a multi-stage gear train. In one particular embodiment, the gear train 104 may include a first stage including a spur gear set. A second stage of the gear train 104 may include an anti-back-drive mechanism that may allow an actuator output, and/or the control element 105 coupled to the actuator output, to maintain a desired position against pressure and/or flowing fluid in the coolant system 109 that may exert a back-driving force on the actuator. In one embodiment, a second stage of the gear train 104 may include a low efficiency worm located between the spur gear set of the first stage of the gear train 104 and an output shaft of the actuator. The low efficiency worm may provide an integral anti-back-drive mechanism. As an alternative to a low efficiency worm, if the back-drive is so great as to overcome the friction in the worm stage, an anti-back-drive clutch or brake may be utilized.

Consistent with the use of the actuator in a cooling system, the gears of the gear train 104 may be formed from materials capable of withstanding elevated temperatures. For example, at least some of the gears may be formed form a metallic material and/or a high temperature plastic resin. Similarly, the motor 102 and gear train 104, as well as various other components of the actuator 100, may be at least somewhat isolated from the operating environment by providing the motor 102, gear train 104, etc. in an at least partially sealed housing. According to one embodiment, the housing may include a plastic material and may be at least partially sealed, e.g., via ultrasonic welding, adhesive bonding, etc. Additionally, electrical connection to the motor 102 and/or the position feedback system, if any, may be achieved via an integral connector. According to one embodiment, an integral connector may be formed by inserting terminal pins into a portion of the housing or similar component or by insert molding terminal pins into a portion of the housing or similar component of the actuator 100. Alternatively, electrical connection between the actuator 100 and external systems may be accomplished using a pig-tail type electrical connector.

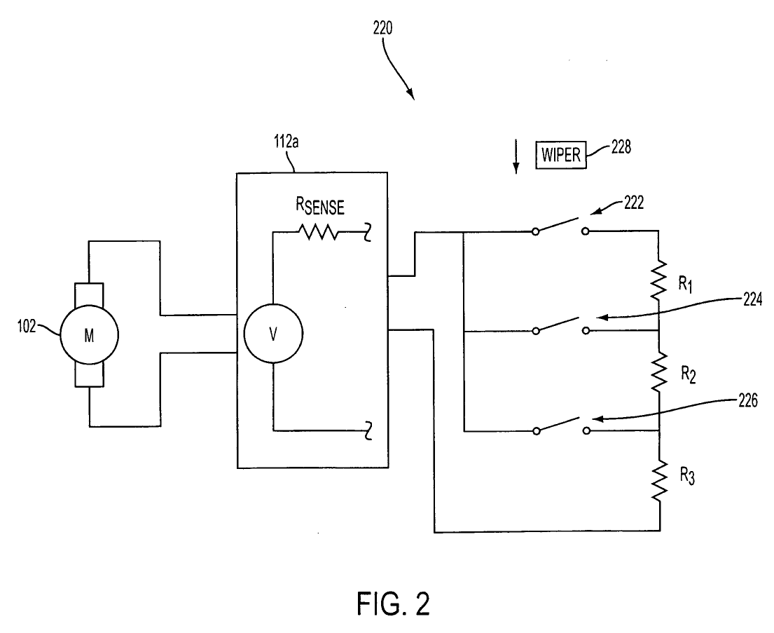

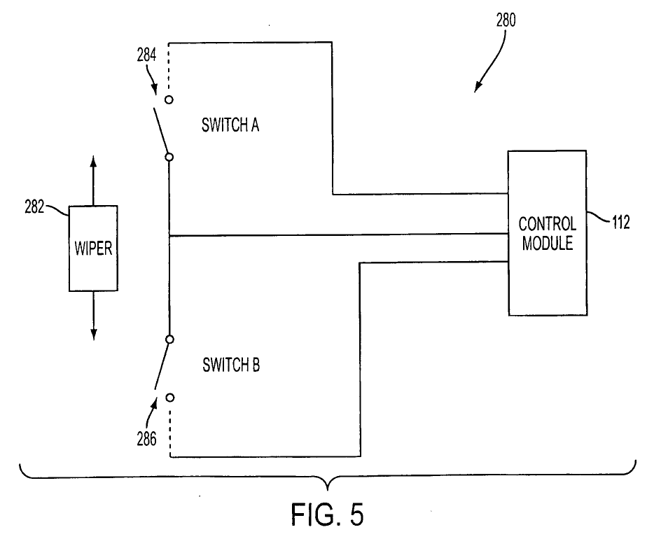

A position feedback system consistent with the present disclosure may include any variety of mechanical, electromechanical, electromagnetic, etc. assemblies, and may be adapted to provide any desired degree of resolution. For example, the position feed back can range from a two position switch configuration, as shown in FIGS. 1A and 5, to other forms which allow greater resolution, as shown in FIGS. 2 through 4 and 6. Furthermore, the actuator may be provided in a modular configuration to allow use of different specific feedback systems to meet the resolution requirements of a particular application. Each feedback system or a portion thereof may be readily removable and replaceable to allow modification of the actuator assembly with little change in the manufacturing process or packaging of the actuator.

In the following embodiments the various position feedback systems may provide an output indicative of a position of the actuator. As used in the description of such feedback systems the position of the actuator may be measured as the position of the control element 105, the position of a driving element disposed between the actuator and the control element 105, the position of an output of the actuator, e.g., a plunger, shaft, etc., the position of a component of the actuator, e.g., gear train, motor, etc, or as the position of another related component.

FIG. 1A illustrates one embodiment of a two switch position feedback system 200 that may include a first switch 202 and a second switch 204 coupled to a common ground 206. The switches 202 and 204 may also be coupled to the control module 112. A wiper 208 or other mechanical feature may activate the first switch 202, e.g. close the switch, when the actuator is in a first position and the same, or a different, wiper or mechanical feature may activate the second switch 204 when the actuator is in a second position. As mentioned, the position feedback 200 system may be coupled to the control module 112 and may provide an output indicating which, if either, of the first switch 202 and second switch 204 is activated. Additionally, the motor 102 of the actuator may be coupled to the control module 112. The control module 112 may activate the motor 102 to drive the actuator to one of the first and second positions, as indicated by activation of the first or second switches 202, 204

Turning to FIG. 2, an embodiment of a position feedback system 220 may be provided that is capable of providing greater resolution of the actuator position. In the illustrated embodiment the feedback system 220 may include a plurality of switches, e.g. 222, 224, 226, that may be activated by a wiper 228 or other mechanical feature. As in the previous embodiment, the feedback system 220 may provide an output to the control module 112 indicative of a position of the actuator. As shown, the feedback system 220 may also include a plurality of resistors R1, R2, R3 wherein activation of the various switches 222, 224, 226 may provide a flow of current through a different number of the resistors R1, R2, R3. A voltage output measured by the control module 112a may be correlated to a position of the actuator. For example, when the first switch 222 is activated, current may flow through all of the resistors R1, R2, R3 resulting in a voltage output indicative of a first position. Activation of the second switch 224 may only cause a flow of current through resistors R2, R3 and may provide a voltage output indicative of a second position. Similarly, activation of the third switch 226 may only cause a flow of current through the resistor R3 and provide a voltage output indicative of a third position of the actuator. In sum, this embodiment of a feedback system 220 may provide a stepped voltage output that is indicative of the position of the actuator. Similar to the previous embodiment, the motor 102 of actuator may be coupled to the control module 112a. The control module 112a may provide an activating signal to drive the actuator to a desired position based on a signal from the feed back system 220. It should be appreciated that the number of switches and resistors may be varied to provide different levels for feedback resolution.

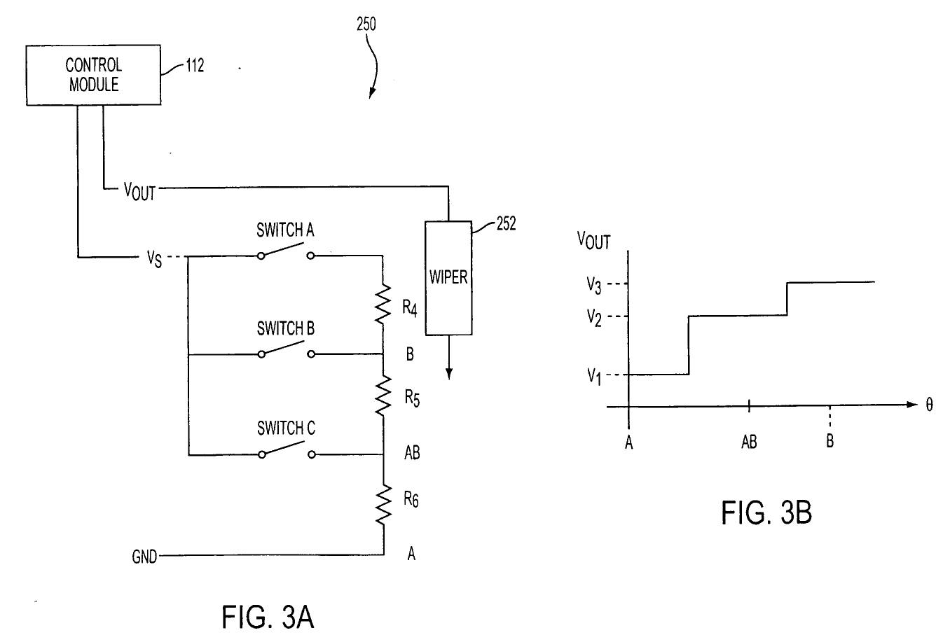

Another embodiment of a feedback system 250 consistent with the present disclosure is shown in FIG. 3. According to this embodiment, the feedback system may include a resistor ladder including resistors R4, R5, and R6. A wiper 252 may make electrical connection at different points along the resistor ladder providing a flow of current through the resistor ladder and the wiper 252. A voltage drop across the resistor ladder/wiper may vary depending upon the position on the resistor ladder contacted by the wiper 252. For example, as shown in FIG. 3B when the wiper 252 contacts the resistor ladder in position B, current may only flow through resistor R4, thereby producing an output voltage V₃. Similarly, when the wiper 252 contacts the resistor ladder at position AB current may flow through resistors R4 and R5, thereby producing an output voltage V₂. When the wiper 252 contacts the resistor ladder at position A, current may flow through resistors R4, R5, and R6, thereby producing an output voltage V₁, e.g. 0V. The output voltage may be measured by the control module 112 which may determine the position of the wiper based on the measured voltage. The wiper 252 may move with a moveable element of the actuator, control element, or associated feature. Accordingly, the voltage output measured by the control module 112 may be correlated to a position of the actuator, control element, or associated feature.

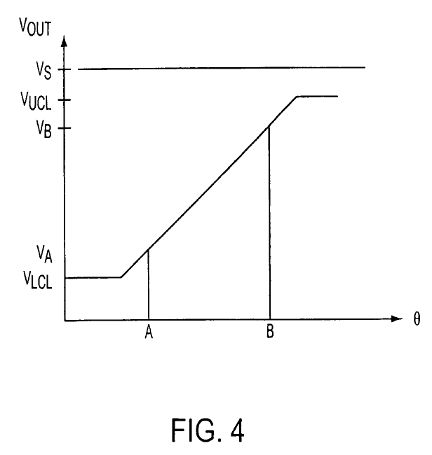

According to another embodiment, the position feedback system may include a potentiometer. The potentiometer may be coupled to the actuator, control element, etc. to provide a varying voltage output over the range of motion of the actuator. In one specific embodiment, the potentiometer may be mounted to a PCB and may provide a voltage output that is related to a position of the actuator about a desired range of movement. As shown in FIG. 4B, the range of motion of the feedback system may be defined by a lower control limit V_{LCL} of the potentiometer and an upper control limit V_{UCL} of the potentiometer. Each position of the actuator within the range of motion of the feedback system may provide voltage output a corresponding the position. For example, position A of the actuator may provide a corresponding voltage output V_{A}. Similarly, position B of the actuator may provide a corresponding voltage output V_{B}.

Consistent with this embodiment, the potentiometer of the position feedback system may be configured either as a linear potentiometer or a rotary potentiometer. As with preceding embodiments, the position feedback system may be coupled to the control module and provide an output to the control module corresponding to the position of the actuator. Furthermore, the control module may be coupled to the motor and capable of energizing the motor to drive the actuator to a desired position based on the output from the position feedback system.

Referring next to FIG. 5, another embodiment of a wiper and switch position feedback system 280 is shown. The feedback system 280 may include a wiper 282 that may move to activate one of a plurality of switches 284, 286 according to different positions of the actuator. The switches 284, 286 may be coupled to, for example, different voltages, thereby allowing the control module 112 to differentiate between activated switches, and thereby perceive the position of the actuator, control element, or associated feature. While only two switches 284, 286 are shown in the illustrated embodiment, a greater number of switches may be employed to provide different levels of position feedback resolution.

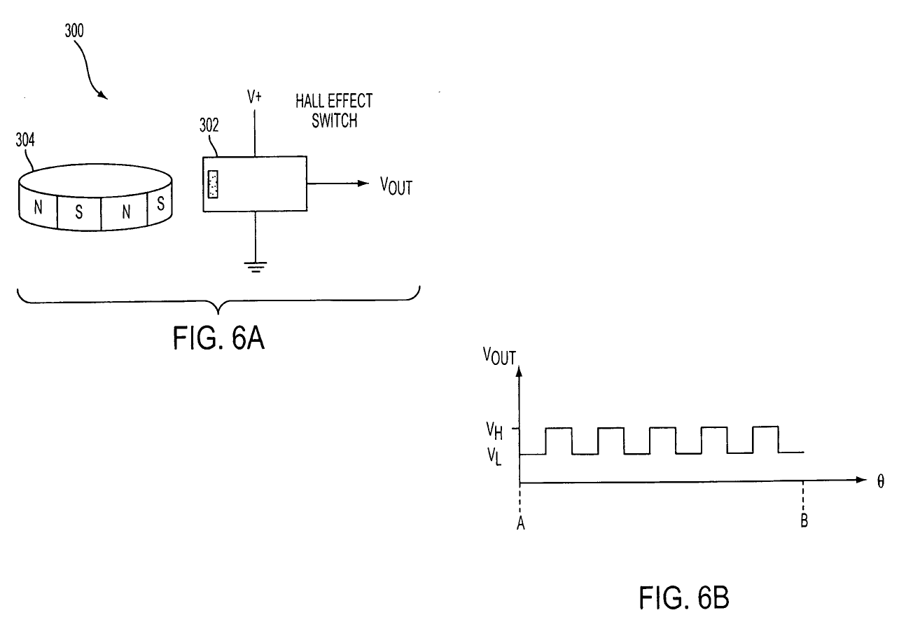

Consistent with yet another embodiment, shown in FIG. 6A, a position feedback system 300 may count increments of movement of the actuator, e.g. output shaft rotational movement. According to the illustrated embodiment, the position feedback system 300 may include a Hall Effect sensor 302 and a magnet wheel 304 including alternating north and south poles around the circumference of the wheel 304. As shown in the voltage-position plot of FIG. 6B, as the wheel 304 rotates relative to the Hall Effect sensor 302, an output of low voltage conditions V_{L} and high voltage conditions V_{H} may be provided corresponding to the proximity of north and south poles around the circumference of the wheel 304 to the Hall Effect sensor 302. Every low voltage V_{L} and/or high voltage V_{H} condition may correspond to an increment of movement of the wheel 304 relative to the Hall Effect sensor 302.

The travel of the actuator per increment of movement of the wheel 304 may be determined, e.g., based on the number of north and/or south poles in one revolution of the wheel 304. Each low voltage V_{L} and/or high voltage V_{H} output may be counted, e.g., by the control module 112 or a dedicated counter (not shown). Accordingly, the movement of the actuator may be determined based on a count of the increments of movement and the direction of movement. The relative position of the actuator may be determined based on a running count of the increments and direction of movement of the wheel 304.

According to a related embodiment, the system may be configured to count increments of linear movement rather than rotational movement. According to such an embodiment, a strip including alternating magnetic poles may be provided to move relative to a Hall Effect sensor. Other embodiments of counting increments of movement of the actuator may also be employed in a similar manner.

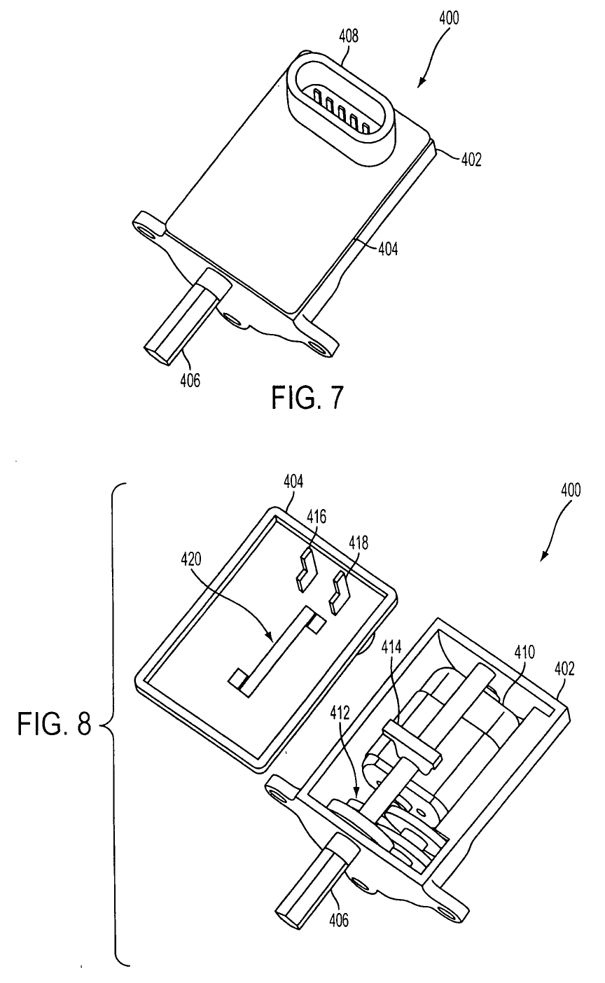

Turning to FIGS. 7 and 8, an embodiment of an actuator 400 consistent with the present disclosure is shown. The actuator 400 may generally include a housing 402 and a cover 404. An actuator output shaft 406 may protrude from the housing 402. Additionally, the cover 404 may include an integral electrical connector 408, e.g. for coupling an electric power source to the motor 410, e.g., via terminals 416, 418, and/or for providing a position feedback signal. With particular reference to FIG. 8, the housing 402 and cover 404 may contain a motor 410 and gear train 412, generally. A wiper 414 may be coupled to the output shaft 406 (and thereby coupled to the motor 410 through the gear train 412), and may move therewith. Alternatively, the wiper may be coupled to one of the gears of the gear train 412.

Consistent with the illustrated embodiment, a modular position feedback system may be provided including the wiper 414 coupled to the output shaft 406 and a removable/replaceable portion 420 disposed on the interior of the cover 404. As such, the feedback system may be integral to the actuator 400. The position feedback system may correspond to one of the feedback systems described with reference to FIGS. 1 through 6, and/or may be of an alternative configuration that will be readily appreciated by those having skill in the art. The removable/replaceable portion 420 of the feedback system may be affixed to the interior of the cover 404, e.g., through adhesive bonding, insert molding, etc. As such, the actuator 400 may readily be adapted to provide different feedback systems and or feedback resolution by providing the cover 404 having different feedback system portions 420 affixed thereto. Similarly, the removable/replaceable portion of the feedback system may be provided on a PCB. The PCB may be disposed on a generic cover. For example, a PCB including a feedback system may be attached to a generic cover by adhesive bonding, heat staking, etc. Alternatively, the PCB containing the removable/replaceable portion of the feedback system may be mounted or disposed in another position in the housing 402.

In a modular configuration, actuators having varying feedback systems and/or varying feedback system resolutions may be manufactured at a reduced cost. The actuator housing 402 including the motor 410, gear train 412, etc., and in some embodiments the cover 404, may be manufactured and/or assembled in a generic manner regardless of a desired feedback system design or resolution. The feedback system may be then included in the actuator simply by providing a PCB having a desired feedback system, or a cover including a desired feedback system, during a final assembly of the actuator.

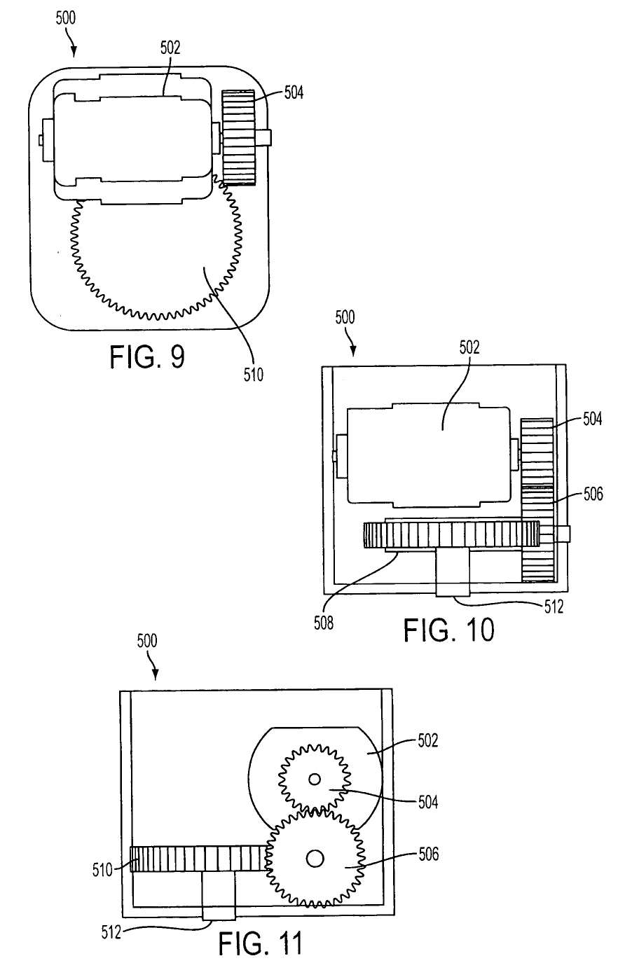

Referring to FIGS. 9 through 11, the mechanical layout of one embodiment of an actuator 500 consistent with the present disclosure is shown from various perspectives. The actuator 500 may generally include a motor 502 coupled to a gear train. The gear train may include a spur gear fist stage including two drivingly engaged spur gears 504, 506. A worm 508 may be rotatably coupled to the second spur gear 506, e.g., by a common axle. The worm 508 may, in turn, be drivingly engaged with a spur gear 510. The spur gear 510 may provide an output 512 for the actuator 500.

It is to be understood that the embodiments that have been described herein are but some of the several which utilize this invention and are set forth here by way of illustration, but not of limitation. It is obvious that many other embodiments, which will be readily apparent to those skilled in the art may be made without departing materially from the spirit and scope of the invention.

1. An actuator comprising:
a motor having an output shaft coupled to a gear train; and
a modular position feedback system, at least a portion of said feedback system being removably replaceable.

2. An actuator according to claim 1 wherein said gear train comprises an anti-backdrive mechanism.

3. An actuator according to claim 2 wherein said gear train comprises at least a first stage and a second stage, and wherein said second stage comprises said anti-backdrive mechanism.

4. An actuator according to claim 2 wherein said anti-backdrive mechanism comprises a worm gear.

5. An actuator according to claim 2 wherein said anti-backdrive mechanism comprises an anti-backdrive clutch.

6. An actuator according to claim 1, wherein said removably replaceable portion of said feedback system is disposed on a printed circuit board (PCB), said portion of said feedback system disposed on said PCB having a predetermined level of feedback resolution.

7. An actuator according to claim 1, wherein said removably replaceable portion of said feedback system is disposed on a housing cover, said portion of said feedback system disposed on said housing cover having a predetermined level of feedback resolution.

8. An actuator according to claim 1 wherein said position feedback assembly comprises a two position switch configuration.

9. An actuator according to claim 1 wherein said position feedback assembly comprises an electromechanical position sensor.

10. An actuator according to claim 1 wherein said position feedback assembly comprises an electromagnetic position sensor.

11. An actuator according to claim 10 wherein said electromagnetic position sensor comprises a Hall Effect sensor.

12. A temperature control system for a coolant flow circuit comprising:
a flow control element disposed in said coolant flow circuit, said flow control element influencing a flow of coolant through at least a portion of said coolant flow circuit; and
a thermostat actuator comprising a motor driving a gear train, said gear train coupled to said control element to control a position of said element, said actuator further comprising a modular position feed back system, at least a portion of said feedback system being removably replaceable.

13. A temperature control system according to claim 12 further comprising a primary mover capable of moving said control element between a fully opened position and a fully closed position.

14. A temperature control system according to claim 13 wherein said thermostat actuator is capable of moving said control element between a fully opened position and at least one partially opened position.

15. A temperature control system according to claim 13 wherein said primary mover comprises a wax motor.

16. A temperature control system according to claim 12 wherein said actuator further comprises an anti-back-drive mechanism.

17. A temperature control system according to claim 16 wherein said anti-back-drive mechanism comprises a worm gear.

18. A temperature control system according to claim 12 wherein said removably replaceable portion of said position feedback system is disposed on a printed circuit board (PCB), said PCB including a feedback system having a predetermined level of feedback resolution.

19. A temperature control system according to claim 12 wherein said removably replaceable portion of said position feedback system is disposed on a housing cover, said housing cover including a feedback system having a predetermined level of feedback resolution.

20. An actuator comprising:
a motor for driving an output shaft; and
a modular position feedback system, at least a first portion of said feedback system being removably replaceable, and at least a second portion of said feedback system being coupled to said motor.

21. An actuator according to claim 20 wherein said second portion of said feedback system is coupled to said motor through a gear train.

22. An actuator according to claim 20 wherein said removably replaceable portion of said feedback system is disposed on a printed circuit board (PCB), said portion of said feedback system disposed on said PCB having a predetermined level of feedback resolution.

23. An actuator according to claim 20 wherein said removably replaceable portion of said feedback system is disposed on a housing cover, said portion of said feedback system disposed on said housing cover having a predetermined level of feedback resolution.

24. An actuator according to claim 20 wherein said gear train comprises an anti-back-drive mechanism.
